(19) United States
(12) Patent Application Publication
(10) Pub. No.: US 2011/0249438 A1
(43) Pub. Date: Oct. 13, 2011

(54) LIGHT SOURCE MODULE AND LIGHTING DEVICE INCLUDING THE SAME

(76) Inventors: Wan Soo Han, Kyunggi (KR); Ho Seok Ko, Kyunggi (KR); Sang Hoon Lee, Kyunggi (KR); Jong Kyo Jeong, Kyunggi (KR); Jin Sung Kwak, Kyunggi (KR)

(21) Appl. No.: 12/863,929

(22) PCT Filed: Dec. 14, 2009
(86) PCT No.: PCT/KR2009/007475

§ 371 Date: Jul. 21, 2010

(30) Foreign Application Priority Data
Dec. 24, 2008 (KR) 1020080133452

(51) Int. Cl. F21V 8/00

(52) U.S. Cl. 362/238; 362/241

(57) ABSTRACT

A light source module and lighting apparatus including the same capable of simply and variously realizing the light distribution angle and light distribution direction of a light source, which are suitable for a given lighting place and environment, without changing the structure of the light fixture of the lighting apparatus.

### BACKGROUND

1. Field of the Invention

The present invention relates to a light source module and a lighting apparatus including the same. More particularly, the present invention is directed to a light source module and a lighting apparatus including the same, which is capable of variously changing the light distribution angle and light distribution direction of a light source without changing the angle of a light fixture.

2. Discussion of the Background Art

Generally, lighting apparatuses, such as lamp posts, include a post and a light fixture equipped with a light source. Such lighting apparatuses are built in footways, bridges, streets, and parks at predetermined intervals, and serve to illuminate the passage of foot passengers or cars at night and of imparting the street with beauty. The lighting apparatuses are generally built along the roadside and the light sources thereof radiate when power is applied thereto from the outside.

Usually, lamp posts are built to have a height of, for example, about 4 to 6 m (security lights) or about 8 to 12 m (lights built along a road where cars pass by). Here, a variety of types of light distribution are required depending on the place where the lamp posts will be built, the width of the road or sidewalk, and the interval between the lamp posts. In order to meet such various demands, it is required to design the internal and external structures of light fixtures to be appropriate for the given situations.

As described above, the lighting apparatuses, such as lamp posts, are installed on the upper portion of each post, the post being vertically built from the ground of the roadside, and current is supplied thereto through electric wire extended along the posts. In general, as light source units, there are used a high voltage mercury light, a fluorescent light, a sodium-vapor light, a general electric light, a Light Emitting Diode (LED) light, etc.

In this regard, because of a semi-permanent life, relatively low power consumption, and high brightness characteristics, the LEDs have recently been getting the spotlight as light sources for such a variety of lighting apparatuses. The lighting apparatuses using an LED as a light source have directionality and light focusing characteristics.

Conventional lighting apparatuses using LED light sources have the following disadvantages (1) to (4):

(1) In order to realize high luminous intensity on the surface under the lamp, a lens or a reflector (light concentrating member using reflection) is separately used in an LED light source unit, so that light is concentrated. As a result, when using a plurality of LED light source units, lenses or reflectors should be individually assembled into the respective LED light source units, thus increasing material and assembly costs and occurrence of product failure.

(2) In particular, an LED light source has the characteristics of radiating light in a single direction, and usually maintains a radiation angle of 90° to 120°. When a lens or a reflector is used, the LED light source is characterized by a radiation angle decreasing to 15° to 60° due to a light concentrating effect. Therefore, when an LED light source is applied to a light post, a larger number of lighting apparatuses should be built or a lamp post having a structure in which inclined surfaces are formed inside of the light fixture of the lighting apparatus in order to effectively light up a wide area. However, there exists a technical limitation in that only a particular type of light distribution can be obtained for a single light fixture, so that a separate light fixture should be manufactured in order to express another type of light distribution.

Thus, the conventional art has a limited performance in expressing various types of light distribution. Particularly, in case of forming excessively inclined surfaces within the light fixture to accomplish wide light distribution characteristics, the size and the weight of the light fixture increase. Accordingly, there is a likelihood that the light fixture may become detached from the post and the design thereof does not fit the trend preferring a slim design.

(3) When light is concentrated using a lens or a reflector in an LED light source unit, glare may occur due to the light directivity characteristics. This may bring about problems of hindering the passage of drivers and passengers, and of increasing the danger of the accidents.

(4) Although there are attempts solve the glare problem pointed out in (3) by applying a cover made of diffusion glass or polycarbonate to a light fixture, the luminous intensity rapidly decreases in this case, reducing the light efficiency.

As discussed above, notwithstanding their various advantages, the conventional LED-based lighting apparatuses such as lamp posts have technical and economical shortcomings. Therefore, it is required to preserve the advantages of the LED-based lighting apparatuses, while to simultaneously overcome the related problems. It is also required to simply and effectively accomplish light distribution characteristics which are suitable for each of various light environments where lighting apparatuses are built.

### SUMMARY

Accordingly, the present invention purports to solve the problems encountered in the prior art, and particularly to provide a LED-based light source module capable of achieve various light distribution characteristics.

The present invention also purports to provide a lighting apparatus capable of simply and variously realizing the light distribution angle and light distribution direction of a light source, which are suitable for a given place and environment, without changing the structure of the light fixture of the lighting apparatus.

According to a first aspect of the present invention, there is provided a light source module comprising:

light emitting units of a light source; and

a reflector module unit equipped with light guide holes each having a reflective surface to determine the direction of radiation of the light source,

wherein the reflector module unit comprises a plurality of first light guide holes each having the reflective surface formed to have asymmetrical directivity relative to the optical axis of the light source so that radiation of the light source is effected in an inclined direction, and

wherein the light emitting units of the light source are respectively provided at one end of each of the plurality of first light guide holes.

The reflector module unit may be structured such that the plurality of first light guide holes are formed in a base member. In this case, it is preferable that the plurality of first light guide holes integrally provided in a peripheral (outer) portion of the base member.

The reflector module unit may further include at least one second light guide hole having a reflective surface formed to have symmetrical directivity relative to the optical axis of the light source so that light emitted from the light source can be radiated in a straight direction (for example, in a direction which is the same as or parallel to the optical axis of the light source). Here, it is preferable that the second light guide hole be integrally provided in the center portion of the base member, and a light emitting unit of the light source be provided at one end of the second light guide hole.

According to one preferred embodiment of the present invention, the other (upper) end of each of the first light guide holes may be in elliptic shape based on the plan (horizontal) view of the base member, while the other (upper) end of the second light guide hole may be in a circular shape based on the plan (horizontal) view of the base member.

According to a preferred embodiment of the present invention, in each of the first light guide holes, “asymmetric” characteristics can be realized in such a way that the tilting angles of the reflective surface can be distinguished from the respective directions. For example, the reflective surface may be configured in combination (mixture) of an inclined surface and a vertical surface. Further, in the second light guide hole, “symmetric” characteristics can be realized in such a way that the tilting angles of the reflective surface are the same when viewed from any direction, and the reflective surface may be configured with an inclined surface.

According to a preferred embodiment of the present invention, protrusions may be formed on the inner circumferential surfaces (that is, the reflective surfaces) of the first and second light source guide holes, so that the irregular reflection of light may be induced, thereby additionally ameliorating the glare problems.

According to a preferred embodiment of the present invention, the base member of the light source module may further include rotation guide ribs having a fastening portion. Such rotation guide ribs can be easily engaged with the rib slit (hole) of a fixing frame installed in the light fixture of the lighting apparatus (which will be set out afterward), thereby serving to enhance the convenience of mounting.

The light source module according to an alternative embodiment of the present invention may include a plurality of coupling holes formed in the base member of the reflector module unit, and may be configured to couple a rotating frame, in which the first light guide hole is formed, to each coupling hole, e.g., by rotatable insertion. In this case, it is preferable that the rotating frame include rotation guide protrusions formed around (outer surface) of the rotating frame so that the rotating frame can be rotated in the base member, and the base member include rotation guide depressions formed around (inner surface) of the coupling hole so that the rotation guide protrusions are placed therein.

According to a second aspect of the present invention, there is provided a lighting apparatus including:

a light fixture housing;

a fixing frame installed in the light fixture housing, and configured to include a plurality of inclined fixing surfaces having angles which are same as or different from each other; and

a plurality of light source modules installed in the respective inclined fixing surfaces of the fixing frame,

where each of the light source module comprises:

light emitting units of a light source; and

a reflector module unit equipped with light guide holes each having a reflective surface to determine the direction of radiation of the light source,

wherein the reflector module unit comprises a plurality of first light guide holes each having the reflective surface formed to have asymmetrical directivity relative to the optical axis of the light source so that radiation of the light source is effected in an inclined direction, and

wherein the light emitting units of the light source are respectively provided at one end of each of the plurality of first light guide holes.

When such a lighting apparatus is used for the purpose of a lamp post, the light fixture housing may be installed in the upper side portion (the top) of the post built on the ground.

The fixing frame installed in the lighting apparatus may further comprise at least one plane fixing surface, where the aforementioned light source module is mounted on the plane fixing surface.

It is preferable that each of the inclined fixing surfaces and/or plane fixing surfaces include a rib slit (hole) corresponding to the rotation guide rib, whereby the light source module can be rotated in such a state that the light source module is coupled to the inclined fixing surface and/or plane fixing surface. Further, the lighting apparatus may further include optical diffusion frames formed along around circumference (or outer surface) of the fixing frame installed in the light fixture.

The light source module and the lighting apparatus in accordance with the present invention have the following advantages:

First, various types of light distribution can be achieved by simply adjusting the (rotation) angle in the reflector module without changing the structure of the light fixture.

Second, the glare problem and the danger of the glare causing accidents can efficiently be reduced by light distributions having a directivity to a certain extent, and optionally by protrusions formed on each of the light guide holes for irregular reflection, instead of using the light directly emitted from an LED light source unit.

Third, a transparent cover may be applied instead of a cover made of diffusion glass or polycarbonate, so that an increase in the luminous intensity can be expected.

Fourth, excessively inclined surfaces need not be formed on the inside of a light fixture. As a result, the light fixture can be designed to be slim and thus decreasing the weight of the lighting apparatus.

Last but not least, lens or reflectors need not be separately assembled to LED-based light source units, so that costs and the occurrence of failure may be reduced due to the increased productivity.

### BRIEF DESCRIPTION OF THE DRAWINGS

FIG. 1 is a plan view schematically showing the configuration of the reflector module unit of a light source module provided according to a first embodiment of the present invention;

FIG. 2 is a cross-sectional view showing the reflector module unit taken along line A-A′ of FIG. 1;

FIG. 3 is a cross-sectional view showing the reflector module unit taken along line B-B′ of FIG. 1;

FIG. 4 is a view schematically showing the configuration of the light emitting units of a light source arranged on the reflector module unit of FIG. 1, and showing the paths of light emitted from the light emitting units of the light source through first and second light guide holes;

FIG. 5 is a view schematically showing the appearance of a lighting apparatus provided according to a second embodiment of the present invention;

FIG. 6 is a plan view schematically showing a configuration in which light source modules are coupled to a fixing frame in the lighting apparatus provided according to the second embodiment of the present invention;

FIG. 7 is a view schematically showing a section taken along line C-C′ of FIG. 6 in the lighting apparatus provided according to the second embodiment of the present invention;

FIG. 8 is a view schematically showing a section taken along line D-D′ of FIG. 6 in the lighting apparatus provided according to the second embodiment of the present invention;

FIG. 9 is a view schematically showing a section taken along line E-E′ of FIG. 6 in the lighting apparatus provided according to the second embodiment of the present invention;

FIG. 10 is a view schematically showing a section taken along line F-F′ of FIG. 6 in the lighting apparatus provided according to the second embodiment of the present invention;

FIG. 11 is a view schematically showing a section taken along line G-G′ of FIG. 6 in the lighting apparatus provided according to the second embodiment of the present invention;

FIG. 12 is a view schematically showing a section taken along line H-H′ of FIG. 6 in the lighting apparatus provided according to the second embodiment of the present invention;

FIG. 13 is a view showing the light source module separated from the fixing frame in the lighting apparatus provided according to the second embodiment of the present invention;

FIG. 14 is a plan view schematically showing a rotation of the light source modules coupled to the fixing frame in the lighting apparatus provided according to the second embodiment of the present invention;

FIG. 15 is a view showing the simulation results of concerning the standard light distribution characteristics of the lighting apparatus depending on the direction of rotation of the light source modules;

FIG. 16 is a view showing the simulation results of concerning the horizontal light distribution characteristics of the lighting apparatus depending on the direction of rotation of the light source modules;

FIG. 17 is a view showing the simulation results of concerning the vertical light distribution characteristics of the lighting apparatus depending on the direction of rotation of the light source modules;

FIG. 18 is a plan view schematically showing a reflector module unit to which a rotating frame is applied;

FIG. 19 is a cross-sectional view schematically showing a reflector module unit to which rotating frames are applied;

FIG. 20 is a plan view schematically showing a method of rotating the rotating frames applied to the reflector module unit; and

FIG. 21 is a cross-sectional view schematically showing a light source module provided with light guide holes each having protrusions formed on reflective surfaces thereof for the purpose of irregular reflection according to another embodiment of the present invention.

### DETAILED DESCRIPTION OF THE PREFERRED EMBODIMENT

Hereinafter, the present invention may be implemented by the following description with reference to the attached drawings. In the description below, it should be understood that although the preferred embodiments of the present invention have been described in details, the present invention is not limited thereto.

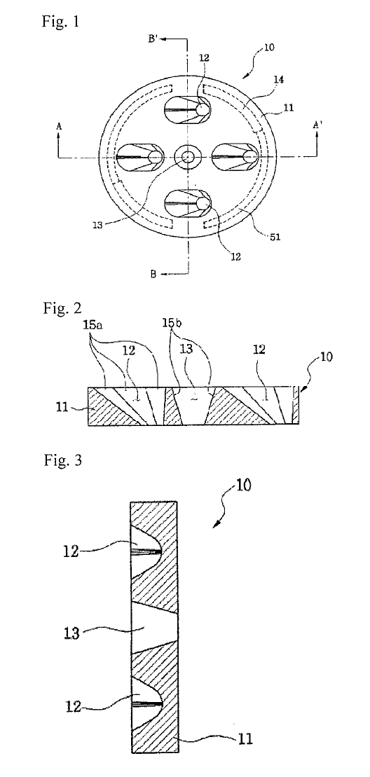

FIG. 1 is a plan view schematically showing the configuration of the reflector module unit of a light source module provided according to a first non-limiting embodiment of the present invention.

FIG. 2 is a cross-sectional view showing a reflector module unit taken along line A-A′ of FIG. 1, and FIG. 3 is a cross-sectional view showing the reflector module unit taken along line B-B′ of FIG. 1.

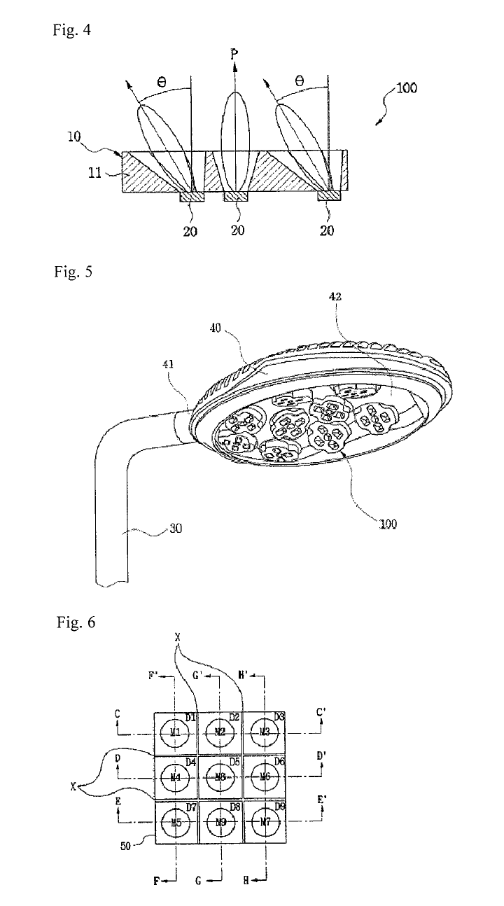

FIG. 4 is a view schematically showing the configuration of light emitting units arranged on the reflector module unit of FIG. 1, and showing the paths of light emitted from the light emitting units of the light source through first and second light guide holes.

Referring to FIGS. 1 to 4, a light source module 100 includes a reflector module unit 10 and the light emitting units 20 of a light source.

According to the embodiment as shown, the reflector module unit 10 includes a base member 11, a plurality of first light guide holes 12, and a second light guide hole 13. The first light guide holes 12 and the second light guide hole 13, respectively, are formed in the base member 11. In this regard, the base member may be structured in a single plate type, and reflective surfaces 15a and 15b, respectively, are formed on the each of the first light guide holes 12 and the second light guide hole 13 to determine the radiation direction of the light source.

Light is emitted from the light source module along inclined paths (that is, light emitted from the light source is radiated in the inclined directions), the light being generated from the light emitting units 20 of a light source provided on one end (bottom in the drawing) of each of the first light guide holes 12. For this purpose, each first light guide hole 12 includes the reflective surface 15a formed to have asymmetrical directivity relative to the optical axis of the light source. As such, it is preferable that the first light guide holes 12 be integrally formed in the outer or peripheral portion (or area) of the base member 11.

With reference to FIG. 4, it is seen that the reflective surface 15a of each of the first light guide holes 12 is formed to have asymmetrical directivity based on the vertical sectional view of the base member 11. Here, the other (upper) end of the first light guide holes 12 may be in an elliptic shape based on the plane (horizontal) view of the base member 11. In implementing such asymmetrical characteristics, the reflective surface of the first light guide holes 12 may be configured in combination (mixture) of an inclined surface and a vertical surface. As such, the tilting angles of the respective reflective surface can be distinguished from the respective directions (the extent to which the reflective surface of the light guide hole is inclined may be differently viewed depending on the observation direction).

Meanwhile, in accordance with the embodiment, the second light guide hole 13 is located at the center portion of the reflector module unit 10. Preferably, it is integrally formed at the center portion (area) of the base member 11. The second light guide hole 13 enables light to be radiated in the straight direction of the light emitted from the light source (P; the same or parallel to the optical axis of the light source in FIG. 4). For this, the reflective surface 15b of the second light guide hole 13 is formed to have symmetrical directivity relative to the optical axis of the light source.

Referring to FIG. 4, the reflective surface of the second light guide hole 13 has the symmetrical directivity (or a shape) based on the vertical sectional view of the base member 11. In this case, the other (upper) end of the second light guide hole 13 may be in a circular shape based on the plane (horizontal) view of the base member.

According to one example of the present invention, in order to exhibit the above-mentioned symmetrical characteristics, the inclined angles of the reflective surface 15b may be the same when viewed from all directions. Also, the reflective surface 15b may consist of inclined surfaces.

Although the embodiment which includes a single second light guide hole 13 has been shown in the drawings, a plurality of second light guide holes 13 may be formed if necessary, and are included in the scope of the present invention.

According to another non-limiting embodiment of the present invention, the arrangement of the plurality of first light guide holes 12 shown in FIG. 4 may be modified. In the first light guide holes 12 provided in the peripheral (outer) portion of the base member 11, the vertical surface of the reflective surface 15a may be arranged to be adjacent to the second light guide hole 13 provided at the center portion of the base member 11, while the inclined surfaces of the reflective surface 15a may be arranged to be opposite to the second light guide hole 13 provided at the center portion of the base member 11.

Preferably, the light emitting units 20 of the light source are Light Emitting Diode (LED) modules (for example, LED devices mounted on a Printed Circuit Board (PCB)), and arranged at respective one ends (bottoms) of the first light guide holes 12 and the second light guide hole 13 which are provided on the reflector module unit 10.

According to the embodiment of the present invention, rotation guide ribs 14 each having a fastening portion 14a may protrude at the bottom of the base member 11 so that the light source module 100 can be easily engaged (coupled) and installed within the lighting apparatus. In this regard, it is preferable that the rotation guide ribs 14, which protrude at predetermined intervals (as shown in FIG. 1), have tension for convenience of installation.

As shown in FIG. 4, the light emitted as power is applied to the light emitting units 20 of the light source may be radiated along paths each inclined at a predetermined angle θ through the first light guide holes 12, and in a straight direction P through the second light guide hole 13.

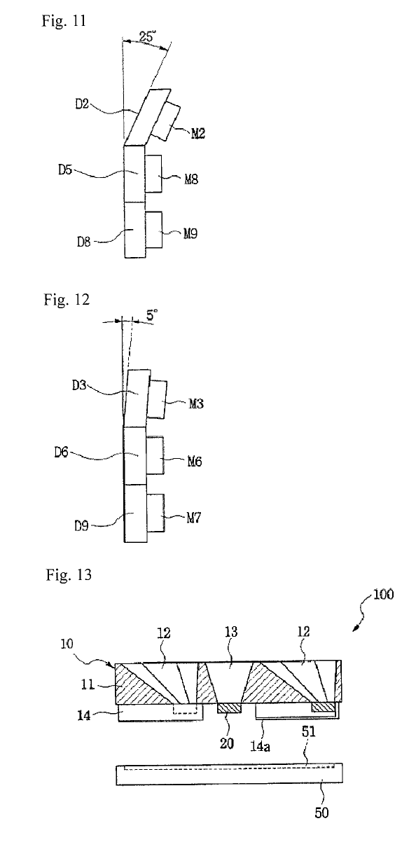

FIGS. 5 to 14 are views showing a lighting apparatus configured by applying a light source module 100 according to the embodiment of the present invention, in particular, views showing another non-limiting embodiment related to a lighting apparatus suitable for a lamp post.

FIG. 5 is a view schematically showing the appearance of a lighting apparatus provided according to the second embodiment of the present invention. In accordance with the lighting apparatus as shown, a light fixture (or a light fixture housing) 40 is installed in the post 30 built on the ground (preferably, vertically), in particular, at the upper portion of the post 30 via an arm-holder 41. In the light fixture 40, a plurality of light source modules 100 are coupled to a fixing frame (not shown in FIG. 5) positioned at the bottom thereof. Further, a metal plate 42 having a plurality of holes arranged to correspond to the light source modules is installed as a reflective plate, and the light source modules 100 are exposed to the outside through the holes. The metal plate 42 may be fabricated to be indented to adapt to the shape of the fixing frame located inside.

FIG. 6 is a plan view schematically showing a configuration in which the light source modules are coupled to the fixing frame in the lighting apparatus provided according to the second embodiment of the present invention.

According to the drawing, the fixing frame 50 is divided into a plurality of divided surfaces (for example, 9 surfaces) and is partially cut away along the cut-away lines X, so that plane fixing surfaces D5 and D8 and inclined fixing surfaces D1, D2, D3, D4, D6, D7, and D9 having angles which are the same or different from each other (i.e., having orientations which are the same or different from each other) are formed.

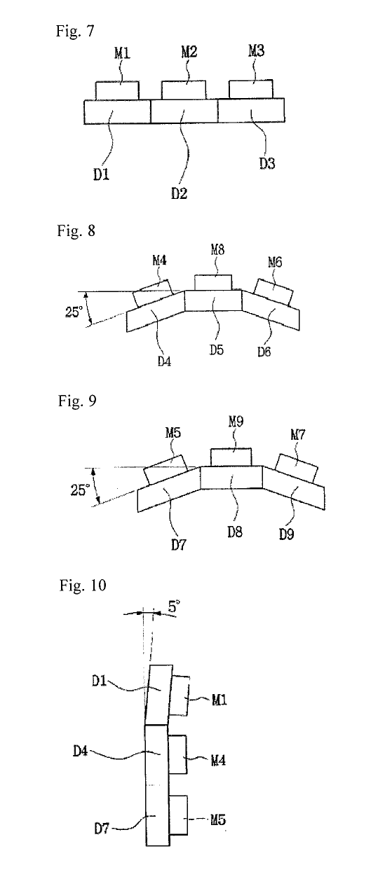

FIGS. 7 to 12 are views schematically showing respective sections taken along line C-C′, line D-D′, line E-E′, line F-F′, line G-G′, and line H-H′ of FIG. 6 in the lighting apparatus.

Referring to the drawings, the inclined angles relative to the inclined fixing surfaces D1 and D3 are maintained to be the same, for example, at about +5°, and the inclined angles relative to the inclined fixing surfaces D4, D6, D7, and D9 are maintained to be the same, for example, at about −25°. Further, the inclined angle relative to the inclined fixing surface D2 is maintained, for example at about +25°. The detailed inclined angle of such an inclined fixing surface should be understood as illustrative, and thus the present invention is not limited thereto. For example, in order to increase the efficiency of light distribution, the respective inclined angles may be further increased or decreased, if necessary.

Here, the base member 11 of the light source module 100 may be coupled to each of the plane fixing surfaces D5 and D8 and the inclined fixing surfaces D1, D2, D3, D4, D6, D7, and D9. In order to couple the base member 11 to each of the plane fixing surfaces/the inclined fixing surfaces, preferably, a rotation guide rib 14 having a fastening portion 14a is formed on the base member 11, and a rib slit 51 corresponding to the rotation guide rib 14 is formed on each of the plane fixing surfaces D5 and D8 and the inclined fixing surfaces D1, D2, D3, D4, D6, D7, and D9.

Specifically, when the rotation guide rib 14 is inserted into the rib slit 51 in a forced (tight) insertion manner, the rotation guide rib 14 does not separate away from the rib slit 51 due to the fastening portion 14a provided with the rotation guide rib 14. Further, the light source module 100 can rotate clockwise or counterclockwise at a predetermined angle in such a state that the rotation guide rib 14 is engaged with the rib slit 51 (refer to FIGS. 1 and 13).

Although the rotation guide rib 14 is engaged with the rib slit 51 of the fixing frame 50 in the exemplified embodiment, the light source module 100 may be directly coupled to the fixing frame 50 without such an engagement, if necessary.

Meanwhile, the details of the light source module 100 are the same as in the first aspect of the present invention, and the duplicated description thereof will be omitted below.

Further, a cover made of transparent material, for example, tempered glass, is provided on the front surface of the light fixture 40, so that light emitted from the light source module 100 can be radiated to the outside of the light fixture 40 through the cover. As such, the cover may be made of a transparent plastic material including a dispersing agent so that light is diffusely emitted with higher efficiency.

In brief, in the case of the embodiment shown in FIGS. 7 to 12, a plurality of light source modules 100, are mounted on the fixing frame 50 within the light fixture 40, each of the light source modules 100 including the reflector module unit 10 and the light emitting units 20 of the light source, which are configured to set the radiation direction of light using the light guide holes formed to have symmetric/asymmetric directivity. The light source modules 100 are mounted on the respective plane fixing surfaces D5 and D8 and inclined fixing surfaces D1, D2, D3, D4, D6, D7, and D9 which constitute the fixing frame 50.

When the light source modules 100 of the light fixture 40 emit and radiate light, the radiated light may have improved light distribution characteristics on the ground by adjusting the installation angles within the light fixture 40 and by using the first light guide holes 12 and the second light guide hole 13 of the reflector module unit 10, each of the first light guide holes 12 and the second light guide hole 13 respectively having symmetric and asymmetric directivity.

For example, when the light source modules 100 are mounted on the respective plane fixing surfaces D5 and D8 and inclined fixing surfaces D1, D2, D3, D4, D6, D7, and D9 of the fixing frame 50, the light source modules 100 which are respectively indicated as M5, M8, M1, M2, M3, M4, M6, M7 and M9, can be configured as in the following Table 1.

TABLE 1

| | Standard | Horizontal | Vertical |
|---|---|---|---|
| M1 | −20 | −45 | 0 |
| M2 | 0 | 0 | 0 |
| M3 | +20 | +45 | 0 |
| M4 | −90 | −90 | 0 |
| M5 | −90 | −90 | 0 |
| M6 | +90 | +90 | 0 |
| M7 | +90 | +90 | 0 |
| M8 | −45 | −90 | 0 |
| M9 | +45 | +90 | 0 |

Here, (−) indicates rotation in a counterclockwise direction, (+) indicates rotation in a clockwise direction, and numerals indicate rotation angles.

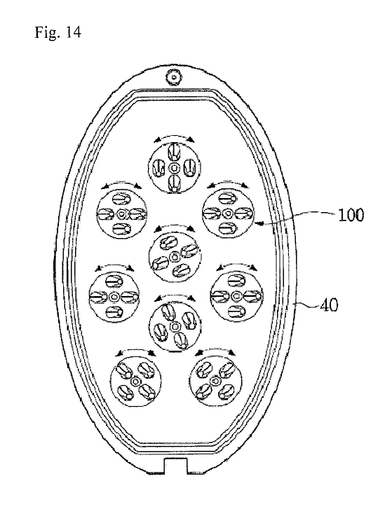

FIG. 14 is a plan view schematically showing a rotation of the light source modules coupled to the fixing frame in the lighting apparatus, according to the second embodiment of the present invention.

In more detail, M1, as the light source module, is mounted on the inclined fixing surface D1;

M2, as the light source module, is mounted on the inclined fixing surface D2;

M3, as the light source module, is mounted on the inclined fixing surface D3;

M4, as the light source module, is mounted on the inclined fixing surface D4;

M8, as the light source module, is mounted on the inclined fixing surface D5;

M6, as the light source module, is mounted on the inclined fixing surface D6;

M5, as the light source module, is mounted on the inclined fixing surface D7;

M9, as the light source module, is mounted on the inclined fixing surface D8; and

M7, as the light source module, is mounted on the inclined fixing surface D9.

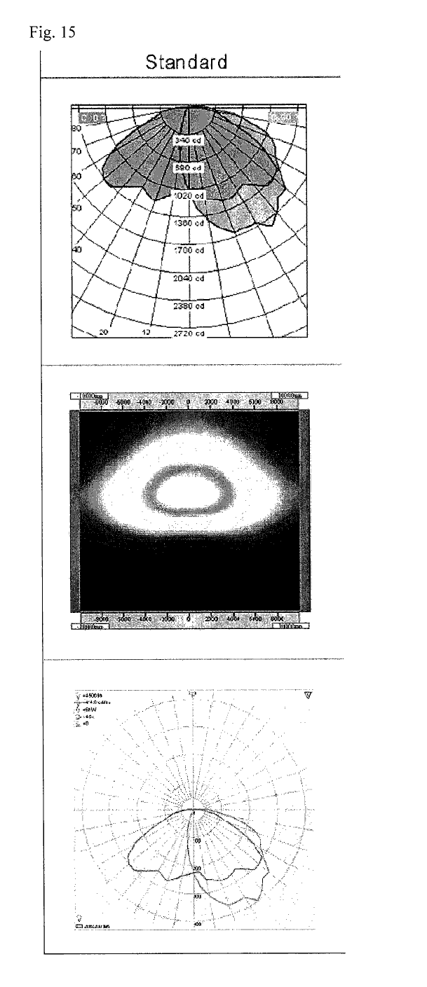

Next, as indicated in Table 1, the light source modules 100 (M1, M2, M3, M4, M5, M6, M7, M8, and M9) are rotated in directions of rotation which are respectively set according to the standard, horizontal, or vertical type (or mode). FIGS. 15 to 17 respectively show the results of simulation in connection with the standard light distribution characteristics, horizontal light distribution characteristics and vertical light distribution characteristics of the lighting apparatus depending on the directions of rotation of the light source modules.

As with the standard type, the light distribution characteristics are such that light is spread out in the front direction and right and left directions of the post 30 (refer to FIG. 15).

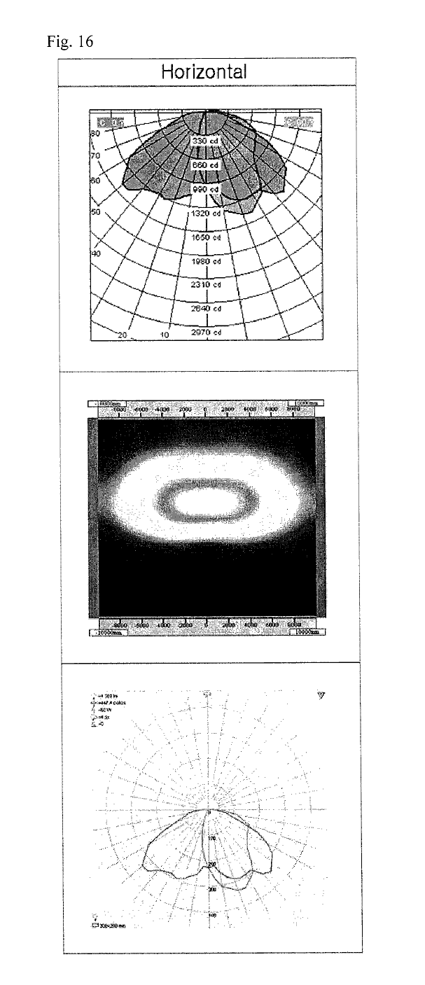

As with the horizontal type, the light distribution characteristics are such that the distribution width of light in the front direction of the post 30 is reduced but the distribution width of light in the right and left directions of the post increases compared with the standard type (refer to FIG. 16).

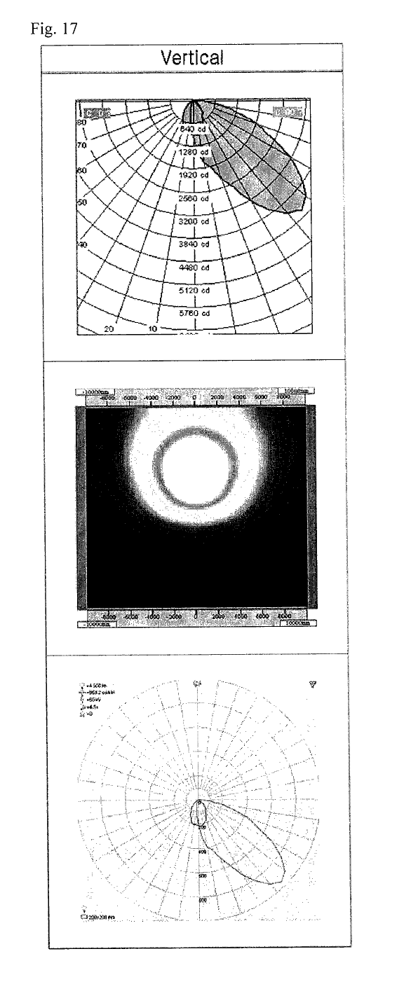

As with the vertical type, the light distribution characteristics are such that the light distribution is not effected in the front direction of the post 30 but light is spread out in a direction turned in one side from the front direction of the post 30 (refer to FIG. 17).

In the present specification, the example in which the light source modules 100 (M1, M2, M3, M4, M5, M6, M7, M8, and M9) are rotated as set out in Table 1 should be understood in the illustrative sense. According to the above-described embodiment, when the light distribution characteristics should be changed under a specific lighting environment, the direction and degree of rotation can be easily modified.

Meanwhile, the reflector module unit of each of the light source modules according to the present invention is not limited to the above-described configuration, but can be realized in various modified forms which will be described in detail below.

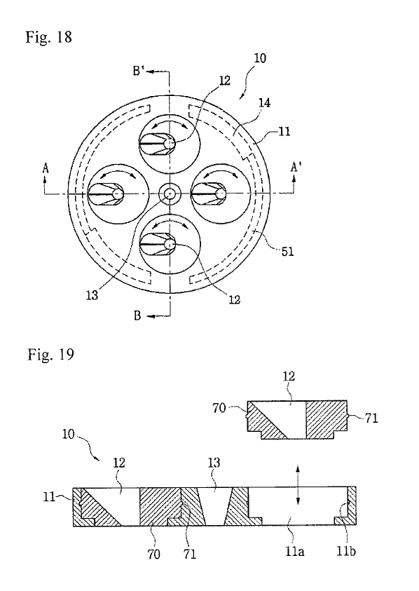

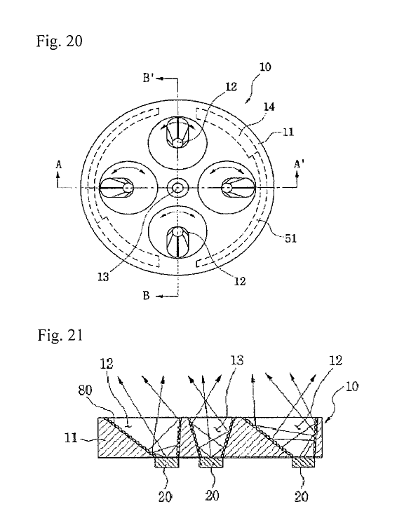

FIGS. 18 and 19 are respectively a plan view and a cross-sectional view schematically showing the reflector module unit to which the rotating frame is applied. Further, FIG. 20 is a plan view schematically showing the rotation of the rotating frames applied to the reflector module unit.

In the embodiment as shown, a plurality of coupling holes 11a are formed in the base member 11 of the reflector module unit 10, preferably, in the peripheral (or outer) portion of the base member 11. Further, a plurality of first light guide holes 12 are integrally formed in respective rotating frames 70. As such, each of the rotating frames 70 may be configured to be coupled to each of the plurality of coupling holes 11a by rotatable insertion.

According to the preferred example of the present invention, rotation guide protrusions 71 are formed on (or along) the outer peripheral surface of each of the rotating frames 70, while rotation guide depressions 11b are provided on (along) the inner peripheral surface of each of the coupling holes 11a of the base member 11. As such, the rotation guide protrusions 71 are placed in the rotation guide depressions.

Therefore, when the plurality of rotating frames 70 have been coupled to the reflector module unit 10, it is possible to individually vary the direction of the first light guide holes formed in the respective rotating frames 70, for example in such a way that the first light guide holes have directions different from each other as shown in FIG. 20. This is distinguished from the previous example (for example, refer to FIGS. 1 to 4, 13, and 14) in which the first light guide holes 12 are fixed to face a certain direction. Referring to FIG. 20, in each of the first light guide holes 12, the vertical surface of the reflective surface is arranged to be adjacent (near) to the second light guide hole 13, while the inclined surface of the reflective surfaces is arranged to be opposite to the second light guide hole 13. As described above, when the rotating frames are used, the directivity of the first light guide holes 12 can be easily changed by performing the simple operation of rotation.

The same reference numerals are used to designate the same elements (for example, the light emitting unit of the light source) as described above, and thus the duplicate description thereof will be omitted below.

FIG. 21 is a cross-sectional view schematically showing a light source module provided with light guide holes each having protrusions formed on reflective surfaces thereof for irregular reflection, according to another non-limiting embodiment of the present invention.

As shown in the drawing, a plurality of protrusions 80 are formed on the inner peripheral surfaces (i.e., the reflective surface) of each of the first light guide holes 12 and/or the second light guide hole 13 for irregular reflection. The aforementioned embodiment is advantageous in that not only the angle of light distribution can be widened, but also the glare problem arising from the straight directivity of LED light can be further reduced.

The present invention is not limited to the above-described embodiments, those skilled in the art will appreciate that various modifications are possible without departing from the gist of the present invention as disclosed in the accompanying claims, and the modifications are disclosed in the accompanying claims.

What is claimed is:

1. A light source module, comprising:
light emitting units of a light source; and
a reflector module unit equipped with light guide holes each having a reflective surface to determine the direction of radiation of the light source,
wherein the reflector module unit comprises a plurality of first light guide holes each having the reflective surface formed to have asymmetrical directivity relative to the optical axis of the light source so that radiation of the light source is effected in an inclined direction, and the light emitting units of the light source are respectively provided at one end of each of the plurality of first light guide holes.

2. The light source module according to claim 1,
wherein the reflector module unit comprises a base member formed in a single plate, and the plurality of first light guide holes are integrally provided in a peripheral portion of the base member.

3. The light source module according to claim 1,
wherein the reflector module unit comprises:
a base member in which a plurality of coupling holes are formed in a peripheral portion thereof, and a plurality of rotating frames in which the first light guide holes are integrally formed therein,
the rotating frames being respectively coupled to the plurality of coupling holes by rotatable insertion.

4. The light source module according to claim 3,
wherein an outer peripheral surface of each of the rotating frames comprises rotation guide protrusions formed thereon, and
an inner peripheral surface of each of the coupling holes comprises rotation guide depressions formed thereon and configured so that the rotation guide protrusions are placed therein.

5. The light source module according to claim 1,
wherein the reflector module unit further comprises:
at least one second light guide hole having a reflective surface formed to have symmetrical directivity relative to the optical axis of the light source so that the radiation of the light source is effected in a straight direction, and
a light emitting unit provided at one end of the second light guide hole,
the second light guide hole being formed at a center portion of the reflector module unit.

6. The light source module according to claim 5,
wherein each of the first light guide holes comprises a reflective surface configured in combination of inclined surface and vertical surface, and the second light guide hole comprises a reflective surface configured with an inclined surface.

7. The light source module according to claim 5,
wherein the reflective surface of each of the first light guide holes and the second light guide hole comprises protrusions for irregular reflection.

8. The light source module according to claim 2,
wherein the base member further comprises rotation guide ribs each having a fastening portion.

9. A lighting apparatus comprising:
a light fixture housing;
a fixing frame installed in the light fixture housing, and configured to include a plurality of inclined fixing surfaces having angles which are same as or different from each other; and
a plurality of light source modules installed in the respective inclined fixing surfaces of the fixing frame,
wherein each of the light source module comprises:
light emitting units of a light source; and
a reflector module unit equipped with light guide holes each having a reflective surface to determine the direction of radiation of the light source,
wherein the reflector module unit comprises a plurality of first light guide holes each having the reflective surface formed to have asymmetrical directivity relative to the optical axis of the light source so that radiation of the light source is effected in an inclined direction, and the light emitting units of the light source are respectively provided at one end of each of the plurality of first light guide holes.

10. The lighting apparatus according to claim 9,
wherein the fixing frame further comprises at least one plane fixing surface, a light source module being installed on the plane fixing surface.

11. The lighting apparatus according to claim 9,
wherein the reflector module unit comprises a base member formed in a single plate, and the plurality of first light guide holes are integrally provided in a peripheral portion of the base member.

12. The lighting apparatus according to claim 9,
wherein the reflector module unit comprises:
a base member in which a plurality of coupling holes are formed in a peripheral portion thereof, and a plurality of rotating frames in which the first light guide holes are integrally formed therein, the rotating frames being respectively coupled to the plurality of coupling holes by rotatable insertion.

13. The lighting apparatus according to claim 12,
wherein an outer peripheral surface of each of the rotating frames comprises rotation guide protrusions formed thereon, and
an inner peripheral surface of each of the coupling holes comprises rotation guide depressions formed thereon and configured so that the rotation guide protrusions are placed therein.

14. The lighting apparatus according to claim 9,
wherein the reflector module unit further comprises:
at least one second light guide hole having a reflective surface formed to have symmetrical directivity relative to the optical axis of the light source so that the radiation of the light source is effected in a straight direction, and
a light emitting unit provided at one end of the second light guide hole,
the second light guide hole being formed at a center portion of the reflector module unit.

15. The lighting apparatus according to claim 14,
wherein each of the first light guide holes comprises a reflective surface configured in combination of inclined surfaces and vertical surfaces, and the second light guide hole comprises a reflective surface configured with an inclined surface.

16. The lighting apparatus according to claim 14,
wherein the reflective surface of each of the first light guide holes and the second light guide hole comprises protrusions for irregular reflection.

17. The light apparatus according to claim 11, wherein the base member further comprises rotation guide ribs each having a fastening portion.

18. The lighting apparatus according to claim 17, wherein each of the inclined fixing surfaces comprises a rib slit corresponding to each of the rotation guide ribs so that the light source module is coupled to the inclined fixing surface and is rotatable.

19. The lighting apparatus according to claim 9, further comprising a post, wherein the light fixture housing is coupled to an upper portion of the post.
